(19) United States
(12) Patent Application Publication
(10) Pub. No.: US 2025/0182433 A1
(43) Pub. Date: Jun. 5, 2025

(54) SYSTEMS AND METHODS FOR THERMAL INSPECTION OF EQUIPMENT USING OBJECT DETECTION AND SEGMENTATION MODELS

(71) Applicant: Cameron International Corporation, Houston, TX (US)

(72) Inventors: Ali Rezaei, Houston, TX (US); Nasser Ghorbani, Houston, TX (US); Oleg O. Medvedev, Missouri City, TX (US)

(21) Appl. No.: 18/967,901

(22) Filed: Dec. 4, 2024

Related U.S. Application Data
(60) Provisional application No. 63/606,235, filed on Dec. 5, 2023.

(51) Int. Cl. G06V 10/25; G06T 7/10; G06V 20/17; G06V 20/52; H04N 23/23

(52) U.S. Cl. CPC G06V 10/25; G06T 7/10; G06V 20/17; G06V 20/52; H04N 23/23; G06V 2201/07

(57) ABSTRACT

This disclosure generally relates to systems and methods for inspecting one or more equipment of a facility. The system may be configured to obtain one or more images including an equipment from one or more cameras, wherein the one or more cameras are fixed within the facility or are attached to an unmanned autonomous vehicle; focus the one or more images on an area of interest with an object detection model to generate a boundary box around the equipment; focus the one or more images on the area of interest with a segmentation model to generate a mask around the equipment based on the boundary box; obtain one or more masked images from the segmentation model; and analyze the one or more masked images to obtain an image analysis of one or more parameters of the equipment.

### CROSS-REFERENCE TO RELATED APPLICATION

The present application is a U.S. Non-Provisional Patent application claiming benefit of U.S. Provisional Patent Application No. 63/606,235, entitled “THERMAL INSPECTION FOR OIL AND GAS FACILITY ASSETS”, filed Dec. 5, 2023, which is herein incorporated by reference.

### BACKGROUND

The present disclosure generally relates to systems and methods for thermal inspection of equipment in a facility.

Regular thermal inspection is an essential part of the prognostic health management (PHM) of oil and gas equipment that either have moving parts (e.g., rotational, reciprocating) or are designed to operate within a specific temperature range. A regular thermal inspection for equipment with moving parts is necessary because friction caused by an abnormal part movement increases the temperature, which may negatively impact the performance of the equipment or even shorten its life cycle. In the second type of equipment, the temperature has to stay in an optimum range for the best performance. Examples of both types of assets in oil and gas facilities include pumps, compressors, heat exchangers, and other electrical devices with boards and fuses. It is critical to regularly check the temperature range and distributions in these assets to make sure they operate in the optimum operating condition. Therefore, any abnormal temperature can be attributed to the unusual behavior of the system and may suggest early maintenance.

The current state of the art is a semi-manual thermal inspection on a non-regular basis (this excludes the fixed continuous sensors). For this purpose, an infrared (IR) camera is carried by a human, a robot, or a drone, and each piece of equipment is inspected individually. The inspections are done in real-time while looking at the screen of the thermal scanner or offline by looking at the saved thermal images after completing data collection. In both cases, data analysis is not automatic such that human intervention and/or analysis is required to focus the inspection on the areas of interest. Also, these workflows are not scalable. A systematic approach toward more efficient and scalable thermal inspection requires a more frequent assessment of the assets' operating conditions and an automated data collection, processing, and inference pipeline. Also, keeping all the previously captured data is necessary, so one can always go back in time and double-check the analyses. Despite the advantages of this systematic approach, there are two bottlenecks: first is the automated data collection task, and second is the analyzing process that must be automated, accurate, and more efficient.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a system for inspecting one or more equipment of a facility may include a processor and a memory comprising instructions executable by the processor. The instructions may be configured to obtain one or more images including an equipment from one or more cameras; focus the one or more images on an area of interest with an object detection model to generate a boundary box around the equipment; focus the one or more images on the area of interest with a segmentation model to generate a mask around the equipment based on the boundary box; obtain one or more masked images from the segmentation model; and analyze the one or more masked images to obtain an image analysis of one or more parameters of the equipment.

In certain embodiments, a method for inspecting one or more equipment of the facility may include obtaining one or more images including the equipment from one or more cameras; focusing the one or more images on the area of interest with the object detection model to generate the boundary box around the equipment; focusing the one or more images on the area of interest with the segmentation model to generate the mask around the equipment based on the boundary box; obtaining one or more masked images from the segmentation model; and analyzing the one or more masked images to obtain the image analysis of one or more parameters of the equipment.

In certain embodiments, a tangible and non-transitory machine readable medium may include instructions to obtain one or more images including the equipment from one or more cameras; focus the one or more images on the area of interest with the object detection model to generate the boundary box around the equipment; focus the one or more images on the area of interest with the segmentation model to generate the mask around the equipment based on the boundary box; obtain one or more masked images from the segmentation model; and analyze the one or more masked images to obtain the image analysis of one or more parameters of the equipment.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of a facility having fixed sensors and an unmanned autonomous vehicle (UAV) carrying sensors for inspecting one or more assets within the facility in accordance with aspects of the present disclosure;

FIG. 2 is a schematic view of the UAV of FIG. 1 and a UAV docking station in accordance with aspects of the present disclosure;

FIG. 3 is a flow chart of a process for monitoring a facility with sensors (e.g., sensors and cameras), wherein the process analyzes images via a multi-model process in accordance with aspects of the present disclosure;

FIG. 4 is a flow chart of an embodiment of a multi-model process using object detection and segmentation models in accordance with aspects of the present disclosure;

FIG. 5 is a flow chart of a process for performing a thermal inspection of equipment in the facility, wherein the process analyzes thermal images of the equipment via a multi-model process to identify anomalies and/or a health condition of the equipment in accordance with aspects of the present disclosure;

FIG. 6 is a flow chart of a process for performing a thermal inspection of equipment in the facility using the UAV, in accordance with aspects of the present disclosure;

FIG. 7 is a schematic image of a pump undergoing image analysis by an object detection model of the multi-model process of FIGS. 3-5, wherein the object detection model forms a boundary box around the pump in accordance with aspects of the present disclosure;

FIG. 8 is a schematic image of the pump undergoing image analysis by a segmentation model after the object detection model forms the boundary box in FIG. 7, wherein the segmentation model generates a masked image having a boundary fit directly about the pump in accordance with aspects of the present disclosure;

FIG. 9 is a schematic image of a valve undergoing image analysis by an object detection model of the multi-model process of FIGS. 3-5, wherein the object detection model forms a boundary box around the valve in accordance with aspects of the present disclosure; and

FIG. 10 is a schematic image of the valve undergoing image analysis by a segmentation model after the object detection model forms the boundary box in FIG. 9, wherein the segmentation model generates a masked image having a boundary fit directly about the valve in accordance with aspects of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

The present disclosure provides an autonomous data-capturing, analysis, storage, and inference workflow. The data capturing is done using an autonomous robot programmed to regularly go near a piece of interested equipment (the equipment and tasks can be grouped together as a mission; missions can be automatic or on-demand), take a thermal image from a fixed position, and send the data to local or cloud-based architecture for further analysis, post-processing, and/or storage. The operators can control the frequency of the data capture and make other changes to the process if needed. The robot will act as a carrier of the IR camera and broadcaster of the thermal images (or videos) after they are captured, and it can be ground-based or aerial. Compared to fixed sensors, a moving device, such as a robot that can carry a single sensor (IR camera or point sensor) around, will enable a more spatially diverse sampling of the interested parameters. This reduces the need for having several versions of the same sensor at different locations. Moreover, operators can save a lot by replacing multiple quantities of different sensors (e.g., gas detector, temperature, etc.), that are placed at different locations, with only a single sensor per parameter and carry the sensor around. This is especially true for larger facilities, which require more sensors. Moreover, another advantage of a moving sensor is that it can identify unexpected changes. For example, if a temperature anomaly happens at some unexpected point, it can be captured by a moving camera.

This disclose also provides an automated and equipment-oriented analysis of the captured thermal images, which will make the thermal inspections more efficient and scalable. The data processing and inference are made using two state-of-the-art computer vision (CV) and artificial intelligence (AI) models that work together automatically to isolate the interested equipment in a thermal image (from the other objects and background) and perform multiple types of analysis on that specific equipment. In some configurations, Segment Anything Model (SAM) and You Only Look Once (YOLO) are the models used for the proposed system. The system will also store the raw and previously analyzed images in a data bank, so the computation architecture can always go back and double-check the processed images for root-cause analysis. The architecture (that could be a digital twin of the facility) can also be used for longer window anomaly detection analyses that are not of concern in the short-term inspection. The computation architecture imports data from multiple sources and analyzes the data. It modifies the existing or creates new inspection missions as suggested by analysis of other data pipelines. This approach offers a much more efficient thermal analysis of the asset.

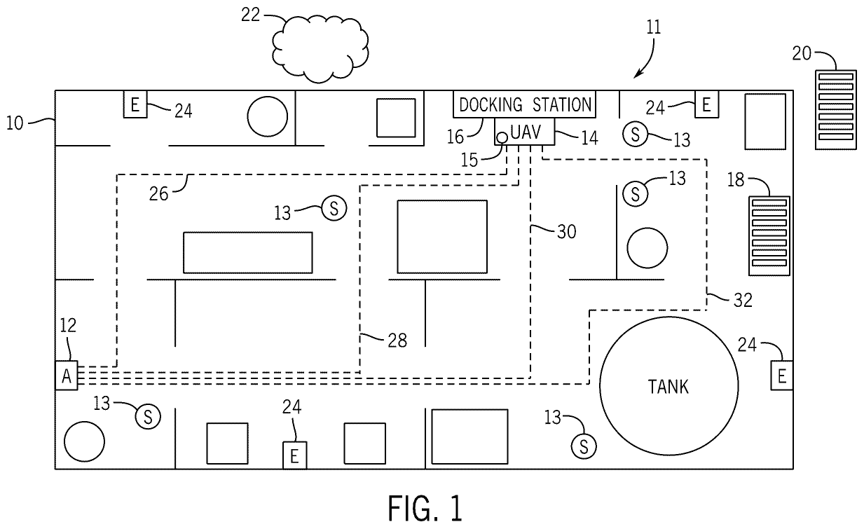

FIG. 1 is a schematic of a facility 10 having various sensors 11 to monitor assets 12, wherein the sensors 11 include fixed sensors 13 (e.g., stationary sensors) and sensors 15 (e.g., mobile sensors) disposed on one or more unmanned autonomous vehicle (UAV) 14. Additionally, as discussed in detail below, one or more computer models and/or artificial intelligence (AI) are used to improve the efficiency of monitoring the facility 10, including guiding navigation of the UAV 14 to any anomalies (e.g., leaks, sounds, lights, etc.) for further inspection of the assets 12, analyzing images from the sensors 11 (e.g., cameras) to focus on an area of interest (AOI) (e.g., a masked image) via an object detection model (e.g., YOLO model) and a segmentation model (e.g., SAM), and analyzing the masked image to obtain information used for controlling the assets 12 in the facility 10. For example, as discussed in detail below, the images may include RGB images, thermal images, and/or optical gas images of the assets 12, and the analysis of the masked image provides information about the assets 12 that can be used for condition based monitoring and control of the assets 12 in the facility 10. In certain embodiments, the analysis of the masked image may provide a thermal analysis that identifies one or more thermal characteristics of the assets 12, such as an average temperature, a maximum temperature, a minimum temperature, a temperature distribution, a temperature at one or more critical locations, and thermal trends over time. Various aspects of the object detection model (e.g., YOLO model) and the segmentation model (e.g., SAM) are discussed in further detail below.

The facility 10 may be an industrial facility, such as a manufacturing facility, an oil and gas drilling and/or extraction facility (e.g., on-shore or off-shore), an oil, gas, or produced water processing facility, a mine, a lab, a refinery, a waste processing center, a water treatment plant, a lumber mill, a machine shop, a wind turbine, etc. In other embodiments, the facility 10 may be a commercial facility, such as an office, a hospital or other medical facility, a restaurant, a retail store, a hotel, a gym, an events venue, a ship, etc. In further embodiments, the facility 10 may be residential facility, such as a house, an apartment building, etc. The facility 10 may also be a public facility such as a school, a government office building, a courthouse, a library, an airport, a train station, a bridge, a highway, etc. The facility 10 may be entirely indoors, entirely outdoors, or have a mix of indoor and outdoor spaces. Similarly, the facility 10 may be on land, in the air, on the water, under water, and so forth.

The facility 10 may include one or more assets 12. The assets 12 may include, for example, pieces of equipment, inventory, raw materials, doors, windows, human workers, robots, computing and/or networking equipment. For example, the equipment may include manufacturing and automation equipment, chemical processing and refinery equipment, fluid handling equipment, or any combination thereof. By further example, the equipment may include combustion engines, furnaces, boilers, reactors, pumps, compressors, mixers, valves, vessels, separators, thermal equipment (e.g., heating, ventilation, and air conditioning (HVAC) systems, heat exchangers, heaters, coolers, etc.), radio frequency identification (RFID) tags, security systems, and so forth. Thus, a variety of the equipment may be fluid containing equipment that can discharge a plume (e.g., gas plume), either intentionally in a controlled manner or unintentionally as an unexpected leak. The disclosed embodiments help to monitor for various leaks and/or plumes using computer models and artificial intelligence (AI) associated with both the fixed sensors 13 and the sensors 15 carried by the UAV 14. In certain embodiments, a variety of the equipment may be thermally variable equipment that generates heat due to moving parts (e.g., rotor, shaft, piston, gears, impellers, turbine, valve, bearings, etc.), experiences heat due to a fluid flow, experiences heat due to a chemical reaction, or any combination thereof. Accordingly, the disclosed embodiments help to monitor for various conditions (e.g., thermal conditions) at the assets 12 using computer models and artificial intelligence (AI) associated with the sensors 11 (e.g., 13 and 15) having one or more cameras (e.g., RGB cameras, thermal cameras, and/or optical gas cameras).

The assets 12 may be periodically inspected by one or more UAVs 14 having one or more sensors 15. Inspection and/or calibration may be performed on a set schedule (e.g., as defined by policies set forth my by the entity that manages the facility, local, state, or federal law or regulation, standard setting organization guidelines, industry best practices, a machine learning-based algorithm, etc.), after a set number of cycles, on demand, in response to some triggering event, upon anomalous data being collected, etc. In some embodiments, if the asset 12 is or includes a measurement device, the inspection by the UAV 14 may include calibration of the measurement device. In some embodiments, the UAV 14 may adjust and/or control some aspect of the asset 12 based on sensor feedback acquired by the sensors 15 of the UAV 14 and/or the fixed sensors 13. For example, the sensors 11 (e.g. 13 and/or 15) may detect an unexpected leak and/or an unexpected thermal condition (e.g., average temperature, minimum temperature, maximum temperature, temperature profile, etc.), and the UAV 14 may close a valve, shutdown a pump or compressor, or otherwise reduce or eliminate the leak and/or thermal condition by one or more control actions.

The sensors 11 (e.g., 13 and 15) may include gas sensors, temperature sensors, pressure sensors, humidity sensors, flow sensors, flow meters, flame sensors, liquid sensors, vibration sensors, accelerometers, motion sensors, audio sensors (e.g., microphones), light sensors, wind sensors (e.g., anemometers), cameras, and so forth. In certain embodiments as discussed in detail below, the sensors 11 (e.g., 13 and 15) include one or more cameras, such as RGB cameras, thermal cameras, and gas imaging cameras, which are used in association with computer models (e.g., object detection and segmentation models). The cameras may be used alone or in combination with additional sensors to obtain additional feedback about the assets 12. For example, in some embodiments, the sensors 11 may include one or more gas sensors configured to detect when certain gases, vapors, fluids, or particulates are present in the air at the facility 10. For example, the gas sensors may be configured to detect a combustible gas (e.g., natural gas, methane, hydrogen, syngas, etc.), an acid gas (e.g., hydrogen sulfide, carbon dioxide, etc.), carbon monoxide, and so forth, the presence of which may be indicative of a leak, a spill, a fire, insufficient venting, and so forth. In some embodiments, the sensors 11 may be permanently installed at the facility 10 as the fixed sensors 13 and/or the sensors 15 carried by the UAV 14. For example, the fixed sensors 13 may be installed at a plurality of fixed positions around the facility 10 for permanent use. This may be advantageous for use in standard operations for the facility 10. In other embodiments, the fixed sensors 13 may be temporary. For example, temporary fixed sensors 13 may be set up in areas of construction. In yet other embodiments, the fixed sensors 13 may be a combination of temporary and permanent. For example, there may be temporary fixed sensors 13 installed in addition to permanent fixed sensors 13 during plant turnarounds or during construction. The fixed sensors 13 may work in conjunction with the sensors 15 carried by the UAV 14 to assist with its inspections. Similar to the fixed sensors 13, the UAV 14 may be permanently installed at the facility 10 via a docking station 16 and/or temporarily deployed at the facility 10 with or without the docking station 16.

The UAV 14 may be land-based, air-based, or liquid-based (e.g., water-based, either surface-based or sub-surface-based). Accordingly, the UAV 14 may be a robot, a rover, an aerial drone, a remotely operated underwater vehicle (ROUV), a water surface drone, and the like. In certain embodiments, the UAV 14 may be a robot having 2, 3, 4 or more legs to walk around the facility 10, a ground vehicle having 2, 3, 4, or more wheels to drive around the facility 10, an aerial drone having one or more propellers, or a combination thereof. In some embodiments, the facility 10 may include a plurality of the UAVs 14 at the same or different locations around the facility 10, wherein the UAVs 14 may work together to provide monitoring of the facility 10.

As described in more detail below, the UAV 14 may dock at a docking station 16 when not in use. The docking station 16 may provide power to the UAV 14 (e.g., charging batteries), communicate with the UAV 14 (e.g., provide routes or other mapping data for download), and perform various other functions via the docking station 16.

As shown, the UAV 14 and/or the docking station 16 may be in communication with a local server 18 located at the facility 10, a remote server 20 disposed at a remote location relative to the facility 10, a cloud 22 (e.g., a public and/or private distributed computing architecture configured to provide storage and/or computing resources via one or more cloud-based computing devices), and/or one or more edge devices 24 (e.g., routers, switches, gateway devices, internet of things (IoT) devices, or other devices connected to a network that have computing capabilities) located at the facility 10. As discussed in more detail below, the UAV 14 may receive route data and/or traffic data from the local server 18, the remote server 20, the cloud 22, and/or the one or more edge devices 24, either directly or via the docking station 16. The route data may be based on satellite images, maps of the facility 10, data collected from fixed sensors 13 at the facility 10, and so forth. Further, in some embodiments, the UAV 14 may transmit requests for, and receive data regarding alternative routes, updated route information that takes one or more sensed items into consideration, and so forth. In certain embodiments, one or more computer models and/or AI may be stored and executed locally on the UAV 14, the local server 18, the remote server 20, the cloud 22, and/or the edge devices 24 to enable intelligent navigation of the UAV 14 to an anomaly, such as a gas leak in the facility 10.

Typically, when performing a routine or scheduled inspection, the UAV 14 receives a pre-programmed and approved route or series of waypoints that includes one or more inspection stops. The UAV 14 departs at a scheduled time, travels the route or follows the waypoints, performs the one or more inspections via the sensors 15, returns collected data, and returns to the docking station 16 or other route end location. In some cases, an asset 12 may generate an alert indicative of the asset 12 or an area around the asset 12 experiencing an anomaly (e.g., condition or problem), such as a fire, a chemical leak/spill, a gas leak, equipment failure, abnormal behavior, a health condition being below a threshold health level, etc. In such cases, an inspection of the asset 12 may be requested on short notice to assess the anomaly and determine a plan of action to address the condition or problem. In other embodiments, the inspection may be an unplanned inspection, an unscheduled inspection, an emergency inspection, a real-time generated inspection (or something along these lines), an alert/alarm triggered inspection, or control system triggered inspection (e.g., based on various sensors data and/or facility conditions indicating a potential real-time problem). However, in some cases a previously generated route from the UAV's 14 current location to the asset 12 to be inspected may not exist. Further, even if a route from the UAV's 14 current location to the asset to be inspected does exist, the route may be planned for a different time of day when traffic from other UAVs, vehicles, humans, wildlife, etc. may be different. Further, obstructions along the route, such as doors being open or closed, etc. may vary dependent upon the time of day.

Accordingly, in certain embodiments, one or more computer models and/or AI may generate a navigation route (e.g., route data) to the anomaly in real-time via intelligent navigation at the UAV 14, the docking station 16, the local server 18, the remote server 20, the cloud 22, and/or the one or more edge devices 24. For example, the one or more computer models and/or AI may generate the navigation route in real-time based on an evaluation of available sensor data from the fixed sensors 13 and the sensors 15 on the UAV 14, operating data (e.g., real-time data, historical data, service/maintenance data, etc.) of various assets 12 at the facility 10, various events (e.g., servicing of certain assets 12) at the facility 10, weather conditions, and any known blockages of areas in the facility 10. The route data may include, for example, multiple route options (e.g., route A 26, route B 28, route C 30, and route D 32), a suggested route of the available options, and/or available traffic data indicative of known routes being traveled by other UAVs at the time, or trends in traffic by humans, vehicles, wildlife, etc. at that time. In certain embodiments, the one or more computer models and/or AI may prompt a user to select a route (e.g., route A 26) from the available routes (e.g., route A 26, route B 28, route C 30, and route D 32), which may or may not be the suggested route, and depart along route A 26 toward the asset 12 upon selection by the user. In certain embodiments, the one or more computer models and/or AI may automatically select the route and proceed with navigation of the UAV 14 to the anomaly for further inspection. Again, the one or more computer models and/or AI may be partially or entirely executed on the UAV 14, the docking station 16, the local server 18, the remote server 20, the cloud 22, and/or the one or more edge devices 24, and thus any remote processing performed away from the UAV 14 may further include transmission of data (e.g., sensor data, route data, etc.) to and from the UAV 14 and the other computing devices (e.g., 16, 18, 20, 22, and/or 24).

As the UAV 14 travels along route A 26, the UAV 14 may utilize one or more onboard sensors 15 (e.g., proximity sensors, laser, sonar, camera, a red, blue, green, depth (RGB-D) camera, etc.) to identify unexpected obstructions along the route, such as other UAVs, humans, wildlife, vehicles, cleaning equipment, closed doors, fire, etc. If the UAV 14 encounters such an obstruction, the UAV 14 may stop in its place or identify a place to stop, and transmit a request for assistance to a nearby edge device 24, the docking station 16, the local server 18, the remote server 20, and/or the cloud 22. For example, if the UAV 14 requests help from a nearby edge device 24, the UAV 14 may transmit route data, which may be the same route data received before commencement of the mission, or a subset of the data received before commencement of the mission, to the edge device 24, along with data collected by the UAV 14 associated with the unexpected obstruction. This data may include, for example, video data, sonar data, and so forth. The edge device 24 may analyze the received data and suggest an alternative route (e.g., route B 28), or suggest that the UAV 14 continue along the planned route (e.g., route A 26). If the UAV 14 chooses to default to an alternative route (e.g., route B 28), the UAV 14 may determine how to get to the alternative route (e.g., route B 28) and then proceed along that path. For example, in the embodiment shown in FIG. 1, the UAV 14 may backtrack along route A 26 until it reaches route B 28 and then follow route B 28 to the asset 12. However, in some embodiments, the recognition of the obstruction and decision to default to an alternative route may be made entirely onboard the UAV 14 via the one or more computer models and/or AI. The UAV 14 may also use onboard sensors 15 to detect fire smoke, leaks, chemical skills, wildlife, authorized people, etc. The UAV 14 may use the one or more computer models and/or AI to evaluate any obstructions and/or issues affecting the navigation route, and automatically change the navigation route to reach the anomaly based on one or more factors (e.g., minimal time based on an urgency of the anomaly, minimal risk based on various hazards, minimal obstacles, etc.). In some embodiments, each obstruction and/or issue affecting the navigation route may prompt the one or more computer models and/or AI to present multiple route options to a user for a user to make a selection of the alternative route. In certain embodiments, the UAV 14 may use the one or more computer models and/or AI to automatically adjust the navigation route in real-time without any stops and/or with minimal stops, thereby reducing the time of arrival of the UAV 14 at the anomaly.

Once the UAV 14 arrives at the asset 12, the UAV performs the inspection of the anomaly via one or more sensors 11 (e.g., 13 and 15). The inspection may include at least imaging by one or more cameras (e.g., RGB cameras, thermal cameras, and/or optical gas imaging (OGI) cameras) by the sensors 11, analysis of images from the cameras by computer models (e.g., object detection and segmentation models) to obtain masked images, and analysis of the masked images to obtain asset conditions (e.g., thermal conditions) of the asset 12. The asset conditions may indicate a health condition of the asset 12, including thermal conditions such as an average temperature, a minimum temperature, a maximum temperature, a temperature at critical locations, a temperature trend over time, or any combination thereof. Thus, the image analysis helps provide useful information about the asset 12, which can be used alone or in combination with other sensor feedback. In some embodiments, the UAV 14 may utilize onboard sensors 15 (e.g., tactile, chemical (e.g., gas/vapor sensors), ultrasound, temperature, laser, sonar, cameras, etc.) to inspect the anomaly at the asset 12. For example, the inspection may include a leak inspection and/or gas plume inspection via gas sensors, wind sensors, and/or cameras. By further example, the inspection may include an analysis of a flow rate, a gas concentration, a leak location, or any combination thereof, of a gas leak and/or gas plume. In certain embodiments, the inspection may include an inspection of the leak location, including a size of the leak (e.g., cross-sectional area of a crack), an identity of a particular part having the leak (e.g., a flange, a valve body, a seal, a pump, a compressor, etc.), or any combination thereof. The inspection may include, for example, checking connections, tag numbers on cables and/or sensors, grounding, checking for abnormal readings (e.g., current, voltage, power, etc.), lack of power, lack of signal, signs of damage, etc. In some embodiments, the UAV 14 may be configured to communicatively couple to the asset 12 (e.g., via a wireless network connection, a wired network connection, cellular data service, Bluetooth, Near Field Communication (NFC), ZigBee, ANT+, LoRaWan, Z-wave, or some other communication protocol) and collect data from the asset 12. In some embodiments, collected data may be transmitted to the docking station 16, the local server 18, the remote server 20, the cloud 22, and/or the one or more edge devices 24 while the UAV 14 is in the presence of the asset 12. However, in other embodiments, the UAV 14 may wait to transmit collected data until the UAV 14 has returned to the docking station 16 or otherwise completed the mission and reached the end of its route. In some embodiments, the UAV 14 may flag the asset 12 for human attention (e.g., service, maintenance, etc.). In some embodiments, the UAV 14 may adjust and/or control one or more aspects of the asset 12 and/or related assets 12 in the facility 10 to reduce or eliminate the anomaly (e.g., gas leak), such as by closing a valve, shutting down a pump or compressor, diverting a fluid flow around the asset 12, or any combination thereof.

Once the inspection of the asset 12 is complete, the UAV 14 travels along a determined route back to the docking station 16, to the end of the planned route, or to another asset 12 for inspection. As previously discussed, as the UAV 14 travels the route, the UAV 14 may use onboard sensors 15 (e.g., proximity sensors, laser, sonar, camera, an RGB-D camera, etc.) to identify unexpected obstructions along the route, such as other UAVs, humans, wildlife, vehicles, cleaning equipment, closed doors, etc. In other embodiments satellite images, or images received from other devices may be used to identify obstructions. If such obstructions are encountered, the UAV 14 may request the assistance of a nearby edge device 24 (e.g., e.g., routers, switches, gateway devices, internet of things (IoT) devices, or other devices connected to a network that have computing capabilities), the docking station 16, the local server 18, the remote server 20, and/or the cloud 22, or the UAV 14 may identify an alternative route on its own and follow the alternative route to the next asset or to the end of the route and conclude its mission.

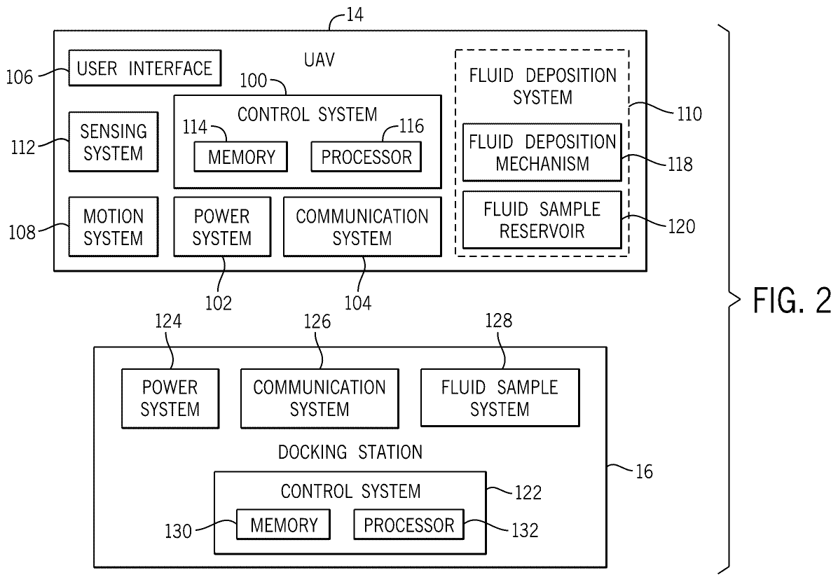

FIG. 2 is a schematic view of the UAV 14 and the docking station 16 of FIG. 1. As shown, the UAV 14 includes a control system 100, a power system 102, a communication system 104, a user interface 106, a motion system 108, a fluid deposition system 110, and a sensing system 112. The sensing system 112 includes one or more of the sensors 15 of FIG. 1. As noted above, the UAV 14 may use one or more computer models and/or AI to improve the efficiency of navigating and monitoring the facility 10, wherein the one or more computer models and/or AI may be disposed on the UAV 14 and/or other computing devices (e.g., 16, 18, 20, 22, and/or 24). As discussed in detail below, the UAV 14 may use the sensors 15 (e.g., cameras) to object images, which can be analyzed with computer models (e.g., object detection and segmentation models) to obtain a masked image of an asset 12. The masked image can then be analyzed to identify a health condition

The control system 100 may include one or more memory components 114 and one or more processors 116 and be configured to control various aspects of the UAV 14, including the various systems shown in FIG. 2 (e.g., the power system 102, the communication system 104, the user interface 106, the motion system 108, the fluid deposition system 110, and/or the sensing system 112). In some embodiments, one or more of the systems of the UAV 14 shown in FIG. 2 may also include control components, including a memory 114 and a processor 116, to control some or all of the operations of the respective system. For example, the control system 100 may act in concert with the motion system 108 to receive a signal from the one or more sensors (e.g., encoders) of the motion system 108 and output a control signal to the one or more motors or movement actuators to control the movement of the UAV 14. Similarly, the control system 100 may coordinate with the sensing system 112 to receive data from the sensing system 112 (e.g., sensors 15) and process or analyze the collected data and determine what action to take next. In further embodiments, the UAV 14 may transmit data to the local server, the remote server, the cloud, and/or one of the edge devices via the communication system 104. In some embodiments, the control system 100 may also perform mission planning tasks, such as navigating to a location, deciding what action to take next, and then executing the next action by coordinating the various other components of the UAV 14 with assistance by the one or more computer models and/or AI.

In some embodiments, the control system 100 may perform navigation and mission planning tasks with assistance by the one or more computer models and/or AI. For example, the control system 100 may receive route data indicating one or more possible routes for a mission. In some embodiments, the route data may also include data representing traffic trends along the possible routes. The control system 100 may be configured to select a route and then control the motion system 108 to navigate the UAV 14 along the selected route. Further, the control system 100 may receive data form the sensing system 112 indicating various aspects of the environment around the UAV 14 and control the motion system 108 to navigate the UAV 14 around one or more obstacles or obstructions detected. Further, the control system 100 may, on its own or with the assistance of another device, identify that a route is obstructed or otherwise impassable, identify and select an alternative route, and use the motion system 108 to navigate the UAV along the route.

The power system 102 may be configured to provide power for various operations of the UAV 14. Accordingly, the power system 102 may include a replaceable or rechargeable battery, a combustion engine, a generator, an electric motor, a solar panel, a chemical-reaction-based power generation system, etc., or some combination thereof. In some embodiments, the power system 102 may be configured to draw power from the docking station 16 in the form of recharging batteries, taking on fuel or other fluids, and so forth.

The communication system 104 may be configured to communicate with devices disposed within the facility (e.g., the docking station 16, the local server, one or more edge devices, one or more assets, a remote controller, a smart phone, a computing device, a tablet, etc.), as well as devices that may be outside of the facility, such as the remote server, the cloud. For example, the communication system 104 may enable communication via a wireless network connection, a wired network connection, cellular data service, Bluetooth, NFC, ZigBee, ANT+, LoRaWan, Z-wave, or some other communication protocol. In some embodiments, the communication system 104 may be configured to encrypt some or all of the data it sends out and decrypt some or all of the data it receives.

The user interface 106 may be configured to receive input from a user configuring or adjusting various settings of the UAV 14. The user interface 106 may include one or more input devices (e.g., knobs, buttons, switches, dials, etc.) and in some cases may include an electronic display (e.g., a screen, array of LEDs, etc.) for providing feedback to the operator. In other embodiments, the UAV 14 may be configured by a separate off-board device (e.g., a remote control, a mobile device, a tablet, etc.) that acts as a user interface 106.

The motion system 108 actuates movement of the UAV 14 on the ground, through the air, through a liquid (e.g., water), along a surface of liquid, or some combination thereof. The motion system 108 may include one or more motors and, in some embodiments, one or more encoders. The motors may drive propellers, legs, wheels, tracks, wings, fins, etc. The encoders may sense one or more parameters of the motors (e.g., rotational speed) and provide data to a control system 100 or a controller within the motion system 108 to generate a control signal to control operation of the motors.

The fluid deposition system 110 may be configured to store fluid samples and emit the fluid samples during sensor inspection. As shown in FIG. 2, the fluid deposition system 110 may include a fluid deposition mechanism 118 and a fluid reservoir 120. The fluid reservoir 120 may be configured to store one or more samples of fluid to be emitted during sensor inspection. The fluid samples may be received via the docking station 16, a fluid sample refill station, or may be manually provided periodically by an operator.

The sensing system 112 may include one or more sensors 15 (e.g., tactile, chemical (e.g., gas/vapor sensors), ultrasound, temperature, laser, sonar, cameras, etc.) configured to sense various qualities and collect data corresponding to the area around the UAV 14. As noted above, the cameras may include one or more RGB cameras, thermal cameras, optical gas imaging cameras, or any combination thereof. The images acquired by the cameras of the UAV 14 may be used alone or in combination with images acquired by the fixed sensors 13. The sensors may be used during inspection of assets, for navigation of the UAV 14 through the facility, and so forth.

The UAV 14 may be configured to return to and connect to the docking station 16 when the UAV 14 is not in use. The docking station 16 may include a control system 122, a power system 124, a communication system 126, and a fluid sample system 128. The control system 122 may be configured to control operations of the docking station 16, including the various systems shown in FIG. 2 (e.g., the power system 124, the communication system 126, and the fluid sample system 128) and perform various tasks associated the UAV 14. The control system 122 may include a memory component 130 and one or more processors 132. In some embodiments, the control system 122 may be configured to receive instructions and/or plans for the UAV 14 via the communication system 126, store the instructions and/or plans in the memory 130 and provide them to the UAV 14 for implementation.

Correspondingly, the control system 122 may also receive data from the UAV 14 and pass data to a local or remote computing device (e.g., the local server, the remote server, the cloud, and/or the one or more edge devices) via the communication system 126.

The power system 124 may contain an internal source of power, such as a generator or battery, and/or be connected to external power, such as a utility grid (e.g., by being plugged into a power outlet), a generator, a battery, etc. Accordingly, the power system 124 may be configured to draw power from the internal or external source of power, in some cases store that power, use the power to run the docking station 16, and also provide power to the UAV 14 (e.g., via the UAV 14 power system 102). Accordingly, the power system 124 may charge the UAV's 14 batteries, provide fuel to the UAV 14, and so forth.

The communication system 126 may include communication circuitry configured to establish a wired or wireless connection with the communication system 104 of the UAV 14. For example, the connection may be a wireless network connection, a wired network connection, a cellular data connection, a Bluetooth connection, an NFC connection, a ZigBee connection, an ANT+ connection, a LoRaWan connection, a Z-wave connection, or a connection via some other communication protocol. The communication system 126 may be configured receive data from the communication system 104 of the UAV 14 while the UAV is docked and/or when the UAV 14 is deployed out in the facility performing inspections or other tasks. The exchanged data may be related to an inspection of assets, mission planning, navigation, power supply, fluid sample supply, threat detection, obstruction detection, and so forth. Further, in some embodiments, the communication system 126 may be configured to communicate with a local or remote computing device via a wireless network connection, a wired network connection, a cellular data connection, a Bluetooth connection, an NFC connection, a ZigBee connection, an ANT+ connection, a LoRaWan connection, a Z-wave connection, or a connection via some other communication protocol. The local or remote computing device may be a desktop computer, a laptop computer, a mobile device, a tablet, a remote controller, a server, an edge device, a cloud-based computing device, etc. In such embodiments, the communication system 126 may be configured to provide and/or receive data regarding the operation of the UAV 14 to the local or remote computing device. For example, the local or remote computing device may be used by an operator to control the UAV 14, either directly, or via the docking station 16.

The fluid sample system 128 may maintain one or more reservoirs of fluid samples and provide fluid samples to the UAV 14 to emit during sensor inspection. In some embodiments, the fluid sample system 128 may store large quantities of the fluid sample materials and use a pump or some other actuator to provide fluid samples to the UAV 14. In such embodiments, the fluid samples may be stored in a reservoir and pumped into the fluid sample reservoir 120 of the UAV 14. However, in other embodiments, the fluid samples may be pre-packaged and the fluid sample system 128 may include an actuator that provides the pre-packaged fluid samples to the fluid deposition system 110 of the UAV 14. In such embodiments, the fluid sample system 128 may also be configured to retrieve used fluid sample packaging from the UAV 14 after the fluid samples have been emitted. The fluid samples may include a plurality of fluid samples disposed in respective sample containers, wherein the fluid samples may correspond to each of the gases being sensed by the various sensors 11.

It should be understood that the embodiments of the UAV 14 and docking station 16 shown and described with regard to FIG. 2 are merely examples and are not intended to limit the scope of the present application. As such, embodiments having different combinations of components are also envisaged. The embodiments discussed in detail below may be used with imaging data (e.g., RGB images, thermal images, optical gas imaging, etc.) acquired from another source, including any or all of the sensors 11 (e.g., 13 and 15).

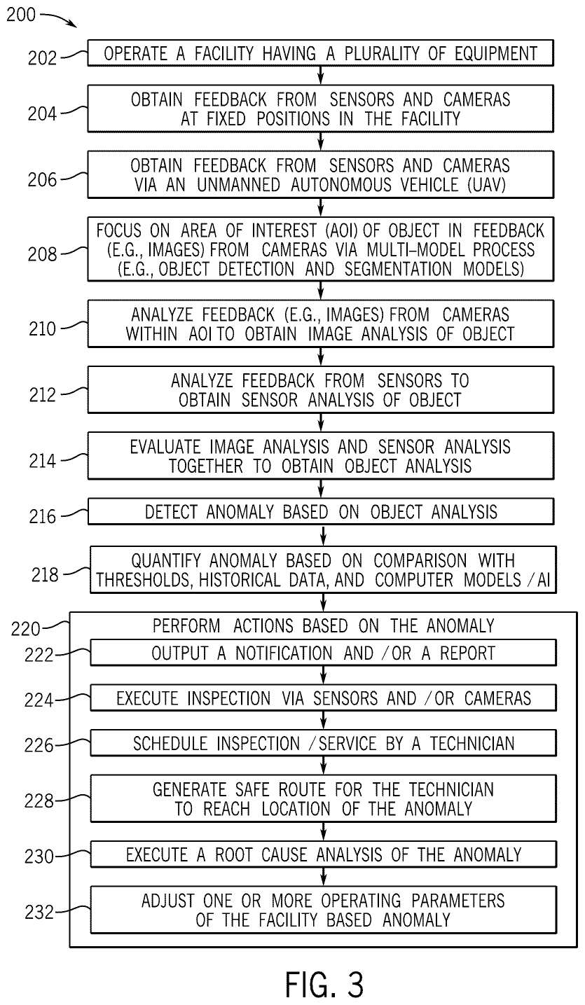

FIG. 3 is a flow chart of an embodiment of a process 200 for monitoring assets 12 in a facility 10. The process 200 may be performed by one or more processor-based computing devices, including the control system 100 of the UAV 14, the control system 122 of the docking station 16, and other computing devices (e.g., 16, 18, 20, 22, and/or 24). In block 202, the process 200 operates the facility 10 having a plurality of equipment (e.g., assets 12). For example, the plurality of equipment may include pumps, compressors, valves, heat exchangers, tanks, mixers, engines, separators, fluid manifolds, pipes, machinery, and bed reactors.

In blocks 204 and 206, the process 200 may inspect the facility 10. In block 204, the process 200 obtains feedback from one or more fixed sensors and one or more fixed cameras. The fixed sensors and fixed cameras may be fixed at certain positions in the facility 10. For example, the fixed sensors and fixed cameras may be positioned such that the fixed sensors and fixed cameras monitor a particular piece of equipment. In block 206, the process 200 obtains feedback from one or more mobile sensors and one or more mobile cameras via the sensing system 112 of the UAV 14. The UAV 14 may be configured to obtain feedback from substantially the same position every time and/or different positions. The process 200 may inspect the facility 10 on a set schedule, after a set number of cycles, on demand, in response to some triggering event, or upon anomalous data being collected. In some embodiments, an anomaly in the inspection by mobile sensors and mobile cameras of the UAV 14 may trigger inspection by the fixed sensors and fixed cameras. Alternatively, an anomaly in the inspection by the fixed sensors and fixed cameras may trigger inspection by the mobile sensors and mobile cameras of the UAV 14. In certain embodiments, the fixed sensors and fixed cameras correspond to the fixed sensors 13 of FIG. 1, while the mobile sensors and mobile cameras correspond to the mobile sensors 15 of the UAV 14 of FIG. 1. Thus, any discussion of sensors 11 (e.g., 13 and 15) is intended to include various sensors and cameras, such as RGB cameras, thermal cameras, and optical gas imaging cameras.

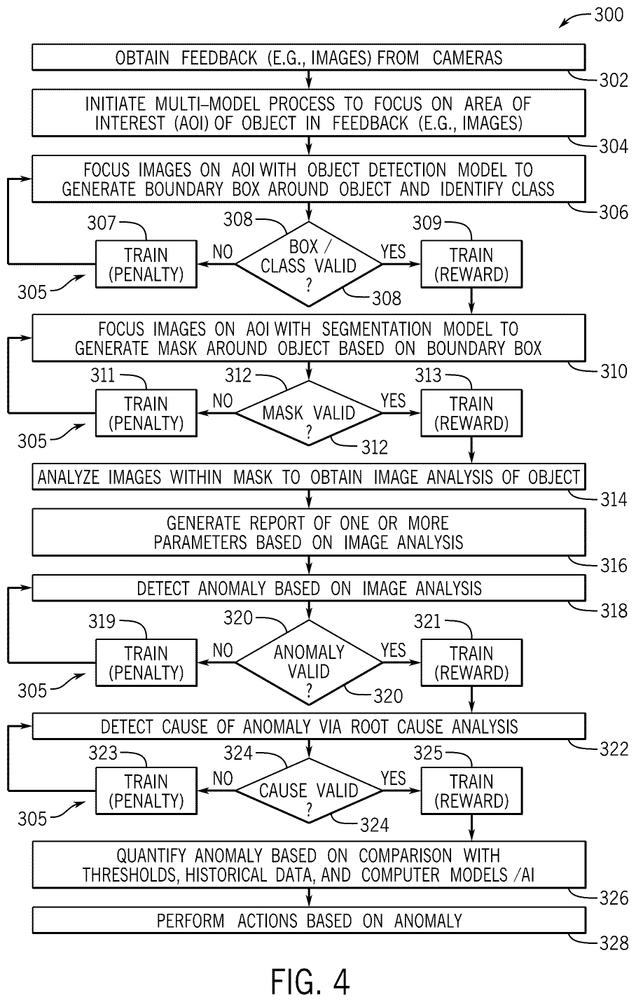

In block 208, the process 200 focuses on an area of interest (AOI) of an object in the images (i.e., the feedback) from the cameras obtained in blocks 204 and/or 206 via a multi-model process. The object may include a particular piece of equipment, a gas plume, a human worker, a robot, a vessel, and so forth. The multi-model process may include analyzing the image using an object detection model and/or a segmentation model to focus on the AOI. The process 200 may use You Only Look Once (YOLO) as the object detection model. Additionally, the process 200 may use the Segment Anything Model (SAM) as the segmentation model. In particular, the process 200 may focus on the AOI using the multi-model process to remove unnecessary background information in the images from the camera, such as background vegetation, pipes, building structures, people, and the like. For example, the process 200 may ultimately focus on only a desired object (e.g., equipment or gas plume) and remove all other image information outside a boundary of that object, thereby producing a masked image of the object. The multi-model process is discussed in further detail below with reference to FIGS. 4-10.

In block 210, the process 200 analyzes the images from the cameras within the AOI (e.g., masked image) to obtain an image analysis of the object. The images may be RGB images, thermal images, and/or optical gas images. The process 200 may be configured to determine one or more parameters of the object based on the images. For example, the process 200 may analyze the thermal image of an equipment (e.g., tank, pump, compressor, valve, etc.) or gas plume to determine a temperature profile (e.g., a thermal map) of the equipment or gas plume. The thermal map may indicate temperature variations according to position (e.g., X, Y, and/or Z coordinates) of the equipment or gas plume. As another example, the process 200 may analyze the RGB image of the equipment or gas plume to determine the shape and size of the equipment or gas plume. By focusing on the AOI and removing unnecessary background information from the images, the process 200 may provide more useful information about the object (e.g., equipment or gas plume) when performing the image analysis in block 210. Thus, if temperatures vary in the background, then this temperature variation will be removed and not impact the image analysis of the object.

In block 212, the process 200 analyzes feedback from sensors to obtain sensor analysis of the object. The sensors may include feedback from the sensors 11 (e.g., 13 and/or 15), and may include any of the sensors and sensor feedback described herein. For example, the sensors may include gas sensors, temperature sensors, pressure sensors, humidity sensors, flow sensors, flow meters, flame sensors, liquid sensors, vibration sensors, accelerometers, motion sensors, light sensors, anemometers, and so forth. The process 200 may be configured to determine one or more parameters of the object (e.g., equipment or gas plume) or affecting the object based on the sensor feedback. For example, the process 200 may determine the pressure of the tank using a pressure sensor. As another example, the process 200 may determine the wind direction from the anemometer as affecting the gas plume. By further example, the process 200 may determine a gas concentration, a flow rate, a gas volume, or a combination thereof, of a gas leak or gas plume. By further example, the process 200 may determine a sound level (e.g., decibels), a vibration level, a flow rate of fluid, a speed of rotation, a position, or any combination thereof, of an equipment (e.g., valve, pump, compressor, engine, etc.).

In block 214, the process 200 evaluates the image analysis (block 210) and the sensor analysis (block 212) together to obtain an object analysis. As such, the process 200 may combine and verify the parameters of the object (e.g., equipment or gas plume) as determined in the image analysis and the sensor analysis to obtain the object analysis. For example, the object analysis may use the pressure determined in the sensor analysis and the temperature profile determined in the image analysis to calculate an approximate volume of gas inside the tank. As another example, the object analysis may use the wind direction determined in the sensor analysis and the shape of the gas plume determined in the image analysis to calculate an approximate area of the gas plume. By further example, the object analysis may use the sound level, the vibration level, the flow rate of fluid, and the speed of rotation of the equipment (e.g., pump, compressor, engine, etc.) of the sensor analysis in combination with the temperature profile (e.g., thermal map) of the equipment from the image analysis to analyze various aspects of the equipment (e.g., positions of bearings, seals, pistons, known hot spots, known areas for issues, etc.).

In block 216, the process 200 detects an anomaly based on the object analysis. The process 200 may use user inputs, historical data, computer models and/or artificial intelligence, operating specifications or any combination thereof, to determine which data points may constitute the anomaly. For example, the process 200 may determine a flowrate parameter constitutes the anomaly if the value of the flowrate parameter exceeds a user input flowrate. As another example, the process 200 may determine a temperature parameter constitutes the anomaly if the temperature parameter of a piece of equipment exceeds the temperature at which the piece of equipment can safely operate according to the equipment's operating specifications. For example, if a temperature at a particular location (e.g., bearing, seal, piston, etc.) is above a threshold temperature, then the temperature may indicate an anomaly at the particular location. By further example, if the temperature (e.g., average temperature and/or maximum temperature) exceeds a threshold in combination with a sound level and/or a vibration level above a threshold, then the object analysis may identify the anomaly as a worn or failing part (e.g., bearing, seal, piston rings, etc.). These analyses also may be part of an anomaly quantification and/or a root cause analysis as discussed in further detail below.

In block 218, the process 200 quantifies the anomaly based on a comparison with thresholds, historical data, computer models and artificial intelligence, or any combination thereof. As such, the process 200 may compare the anomaly to the thresholds, historical data, and/or computer models and artificial intelligence to determine the severity level of the anomaly. For example, if the anomaly constitutes an average temperature or a maximum temperature of the temperature profile of the object (e.g., equipment or gas plume) exceeding a threshold, the process 200 may calculate how much higher the average or maximum temperature is over the threshold and label the anomaly with an appropriate level of severity. The quantification of the anomaly may include the actual measurement value (e.g., average temperature, maximum temperature, or trend in rate of increasing temperature over time), a temperature over the threshold, a percentage over the threshold, or any combination thereof. As another example, if the anomaly is an unexpected gas leak, the process 200 may calculate or estimate the size of the hole causing the gas leak, the flow rate of the gas leak, the volume of the gas leak, or any combination thereof, based on a computer model simulating the leak. In certain embodiments, the quantification of the anomaly may include a score (e.g., a severity score) that indicates the severity of the anomaly on a scale (e.g., increasing severity from 1 to 10, 1 to 100, or the like). The score may be based on each sensor measurement accounted for in the object analysis, wherein certain sensor measurements may be weighted differently from others. For example, vibration feedback may be attributed a higher weight than sound feedback, temperature feedback may be attributed a higher weight that speed feedback, or the like.

In block 220, the process 200 performs one or more actions based on the anomaly. The process 200 may automatically perform the one or more actions upon detecting the anomaly. The actions may include outputting a notification and/or outputting a report describing the anomaly (block 222). The actions may also include executing a root cause analysis (block 230). The notification and/or report may contain the identification of the anomaly (block 216), information regarding the time the anomaly occurred, the location on a map of the facility 10, the location on a 3D model of the object (e.g., equipment or gas plume), the feedback from sensors (blocks 204, 206), the image of the object (e.g., RGB image, thermal image, and/or optical gas imaging) within the AOI (block 208), the image analysis (block 210), the sensor analysis (block 212), the object analysis (block 214), the quantification of the anomaly (block 218), and/or the results of the root cause analysis (block 230). The notification and/or report also may depict a graph or illustration of a trend in one or more parameters (e.g., temperature, pressure, flow rate, sound level, vibration level, etc.) over time, predicted future trends or events (e.g., part failure), and recommended remedial measures. The actions (block 220) may further include scheduling and executing an inspection via the sensors and/or cameras. The sensors and/or cameras may be the fixed sensors and fixed cameras (e.g., sensors 13) and/or the mobile sensors and mobile cameras (e.g., sensors 15) of the UAV 14. The process 200 may instruct the sensors and/or cameras to repeat the inspection of the facility 10 as in blocks 204 and/or 206. Alternatively, the process 200 may instruct the sensors and/or cameras to only repeat the inspection of the object. In certain embodiments, the inspection of block 224 may include different measurements not already taken in blocks 204 and 206, measurements from a different location, angle, or perspective relative to the anomaly, or any combination thereof. For example, if the UAV 14 used in block 206 was a ground based UAV 14, then the inspection of block 224 may deploy an aerial UAV 14 to obtain measurements (e.g., sensor feedback and/or camera images) from one or more locations above the anomaly. Additionally and/or alternatively, the process 200 may schedule a manual inspection and/or service of the object by a technician (block 226). In such embodiments, the process 200 may generate a safe route for the technician to reach the location of the anomaly (block 228), and include a map of the safe route in the notification and/or report (block 222). The actions (block 220) may also include adjusting one or more operating parameters of the facility 10 based on the anomaly (block 232). For example, the adjustments of block 232 may include adjusting a valve to reduce a flow rate, adjusting a pump or compressor to increase or decrease flow, adjusting feeds into a chemical reactor to adjust the chemical reaction, or any combination thereof. The adjustments of block 232 may include control of any of the equipment or assets 12 described herein to help reduce or eliminate the anomaly.

FIG. 4 is a flow chart of an embodiment of a multi-model process 300 using the object detection model and the segmentation model of FIG. 3. The process 300 may be performed by one or more processor-based computing devices, including the control system 100 of the UAV 14, the control system 122 of the docking station 16, and other computing devices (e.g., 16, 18, 20, 22, and/or 24). In block 302, the process 300 obtains feedback (e.g., images) from one or more cameras. The images may be RGB images, thermal images, and/or optical gas images. In block 304, the process 300 initiates the multi-model process to focus the images on the AOI of the object as discussed above in block 208 of FIG. 3.

In block 306, the process 300 focuses the images on the AOI with the object detection model to generate a boundary box around the object (e.g., equipment or gas plume) and identify the class or classification of the object. The boundary box may be a rectangular or square boundary box, a circular or oval boundary box, a polygonal boundary box having 3, 4, 5, 6, or more sides, or any combination thereof. The boundary box may be fit to closely extend around the object. The object detection model used may be customized to the facility 10, including the objects (e.g., equipment and gas plumes) in the facility 10, the map of the facility and locations of the objects within the map, and various operations of the facility 10.

The process 300 may initiate a machine learning/AI training and validation process 305 for the object detection model by evaluating the boundary box and classification at block 308. If the boundary box and class is not valid at block 308, then the process 305 may proceed to train the object detection model by penalizing the machine learning/AI at block 307 and returning to block 306. If the boundary box and class is valid at block 308, then the process 305 may proceed to train the object detection model by rewarding the machine learning/AI at block 309 and proceeding to block 310. For example, the object detection model may be trained on images from the facility 10 or on images of objects similar to the objects used in the facility 10. In certain embodiments, the process 300 may use machine learning/AI to train the object detection model to identify the objects in the facility, such as types or classes of objects in various hierarchal levels. The hierarchical levels may include a first level of objects (e.g., equipment, gas plumes, buildings, etc.), a second level of objects (e.g., types of equipment, types of gas plumes, etc.), a third level of objects (e.g., make, model, etc. of the equipment), and so forth. For example, the types of equipment may include any of the assets or equipment described herein, including pumps, compressors, valves, engines, tanks, separators, reactors, and so forth. The training may involve using the machine learning/AI associated with the object detection model to evaluate a library of existing images when evaluating new images from the cameras. In certain embodiments, the training of the object detection model may be performed prior to deployment in the facility 10, during deployment in the facility 10, and/or whenever new objects are introduced into the facility 10. In some embodiments, the object detection model may be trained using a map (e.g., a two-dimensional and/or three-dimensional map) of the facility 10. For example, the object detection model may identify the object as a pump if the map shows the pump in the same area as the location of acquiring the image of the pump. The object detection model may be trained to identify the class of the object using user input, the data in the cloud 22, and/or references obtained from the internet.

In block 308, the process 305 uses machine learning/AI and/or user inputs to determine whether the boundary box is valid for the object. The boundary box may be considered valid if the entire object fits within the boundary box and the boundary box is closely tailored to fit the object. If the boundary box is valid, the machine learning/AI system is rewarded at block 309. If the boundary box is invalid, the machine learning/AI system is penalized at block 307. Similarly, in block 308, the process 305 determines whether the class of the object is valid. If the class of the object is valid, the machine learning/AI system is rewarded at block 309 but, if the class of the object is invalid, the machine learning/AI system is penalized at block 307. Thus, by rewarding the machine learning/AI system when it provides correct information and penalizing the machine learning/AI system when it provides incorrect information, the machine learning/AI system is trained to better generate the boundary box and identify the class of the object.

In block 310 of the multi-model process, the process 300 focuses the images on the AOI with the segmentation model to generate a mask around the object (e.g., equipment or gas plume) based on the boundary box. The segmentation model uses the boundary box to better determine the object's boundary. In other words, the object detection model guides, focuses, or enhances operation of the segmentation model by providing a first level of focus on the AOI in the image. The output of the segmentation model is a masked image that is further focused on the object within the boundary box. In some embodiments, a user may provide a center point of the object to the segmentation model. The segmentation model may use the center point to better determine the object's boundary.

The process 300 may initiate the machine learning/AI training and validation process 305 for the segmentation model by evaluating the image mask (e.g., masked image of the object) at block 312. If the image mask is not valid at block 312, then the process 305 may proceed to train the segmentation model by penalizing the machine learning/AI at block 311 and returning to block 310. If the image mask is valid at block 312, then the process 305 may proceed to train the segmentation model by rewarding the machine learning/AI at block 313 and proceeding to block 314. In block 312, the process 305 uses machine learning/AI, a library of images, and/or user inputs to determine whether the image mask is valid. The image mask may be considered valid if the image mask includes only the object and includes the object in its entirety. For example, if the image mask has a boundary directly fit around an upper half of a pump but misses a lower half of the pump, then the image mask would be invalid. The validation may occur automatically without user intervention and/or with user input to accept the image mask as valid or reject the image mask as invalid. If the image mask is valid, the machine learning/AI system is rewarded at block 313. If the mask is invalid, the machine learning/AI system is penalized at block 311.

In block 314, the process 300 analyzes the images within the mask to obtain an image analysis of the object (e.g., equipment or gas plume). The image analysis may include determining one or more parameters of the object based on the images. Thus, in block 316, the process 300 may generate a report of the one or more parameters of the object based on the image analysis. The report may be similar to the notification and/or report of block 222 of FIG. 3. Advantageously, the image analysis only analyses details of the image corresponding to the object, and specifically excludes irrelevant background information (e.g., trees, buildings, grass, people, etc.). Thus, the image analysis is generally more accurate by providing statistical information only about the object (e.g., equipment or gas plume). As an example, for a thermal image of the object (e.g., equipment or gas plume), the image analysis includes a thermal image analysis that may evaluate the temperature profile, the average temperature, the minimum temperature, the maximum temperature, the temperature at various critical locations (e.g., bearings, seals, pistons, etc.), the temperature trends over time, or any combination thereof, without the results being biased or degraded due to temperatures of the background (e.g., a person standing nearby, a vehicle with an engine running, etc.). Again, the masked image removes the background information, such that the image analysis focuses only on the object. The process 300 may similarly evaluate RGB images and optical gas imaging to achieve more accurate and relevant results associated with the object. By further example, the image analysis may evaluate the shape and size of a gas plume, thereby enabling an analysis of a volume, flow rate, and/or direction of the gas plume. By further example, the image analysis may evaluate trends in the gas plume over time, such as changing directions of flow and/or the flow rate of the gas leak.

In block 318, the process 300 detects an anomaly based on the image analysis. The process 300 may use user inputs, historical data, computer model and/or artificial intelligence, operating specifications, or any combination thereof, to determine which parameters obtained from the image analysis may constitute the anomaly. In certain embodiments, the anomaly detection may include aspects of block 216 of FIG. 3 as discussed in detail above. For example, the image analysis (e.g., thermal image analysis) may identify one or more temperatures (e.g., average temperature, minimum temperature, and/or maximum temperature) that are above an upper threshold and/or below a lower threshold, thereby indicating that an anomaly is present at the object. The temperatures may be anywhere in the masked image, at specific locations of critical components (e.g., seals, bearings, pistons, etc.), at previously repaired locations, or any combination thereof. By further example, the image analysis may identify a gas plume at an unknown or unexpected location, a gas plume above a threshold (e.g., threshold volume, flow rate, etc.) at any location, a gas plume that is trending in a particular way (e.g., trending larger in volume flow rate, etc.) over time, or any combination thereof.

The process 300 may initiate a machine learning/AI training and validation process 305 for the anomaly detection of block 318 by evaluating whether the anomaly is valid at block 320. If the anomaly is not valid at block 320, then the process 305 may proceed to train the anomaly detection by penalizing the machine learning/AI at block 319 and returning to block 318. If the anomaly is valid at block 320, then the process 305 may proceed to train the anomaly detection by rewarding the machine learning/AI at block 321 and proceeding to block 322. The validation of the anomaly may occur automatically without user intervention and/or with user input to accept the anomaly as valid or reject the anomaly as invalid.

In block 322, the process 300 may detect a cause of the anomaly via a root cause analysis. The root cause analysis may use a library of anomalies associated with various sensor feedback and image analyses to determine the cause of the anomaly. The library of anomalies may be based on historical sensor feedback, simulated operational data for the objects and the facility, historical and simulated images of objects, or any combination thereof, for the specific facility 10 and other facilities have the same or similar objects. For example, the process 300 may determine via the root cause analysis that an unexpected hot spot in the temperature profile of equipment (e.g., pump, compressor, engine, etc.) is caused by a worn or faulty bearing, seal, or piston. As another example, the process 300 may determine via the root cause analysis that a low flowrate of the gas plume is caused by a buildup of materials in an outlet or exhaust stack, a low reaction rate of a reactor, a low combustion rate of a combustion system, or the like.

The process 300 may initiate a machine learning/AI training and validation process 305 for the root cause analysis of block 322 by evaluating whether the determined cause of the anomaly is valid at block 324. If the cause of the anomaly is not valid at block 324, then the process 305 may proceed to train the root cause analysis by penalizing the machine learning/AI at block 323 and returning to block 322. If the cause of the anomaly is valid at block 324, then the process 305 may proceed to train the root cause analysis by rewarding the machine learning/AI at block 325 and proceeding to block 326. The validation of the root cause analysis may occur automatically without user intervention and/or with user input to accept the cause of the anomaly as valid or reject the cause of the anomaly as invalid.

In block 326, the process 300 quantifies the anomaly based on the comparison of the anomaly with the thresholds, historical data, computer models and artificial intelligence, or any combination thereof. For example, the anomaly quantification of block 326 may be the same or similar as described in detail above with reference to block 218 of FIG. 3. As such, the process 300 may compare the anomaly to the thresholds, historical data, and/or computer models and artificial intelligence to determine the severity level of the anomaly.

In block 328, the process 300 performs one or more actions based on the anomaly. For example, the actions of block 328 may be the same or similar as described in detail above with reference to block 220 of FIG. 3. The actions may be performed at least partially or entirely by one or more processor-based computing devices. The actions may include outputting a notification and/or outputting a report describing the anomaly; scheduling and executing an inspection via the sensors and/or cameras; scheduling a manual inspection and/or service of the object by a technician; generating a safe route for the technician to reach the location of the anomaly; and adjusting one or more operating parameters of the facility 10 based on the anomaly.

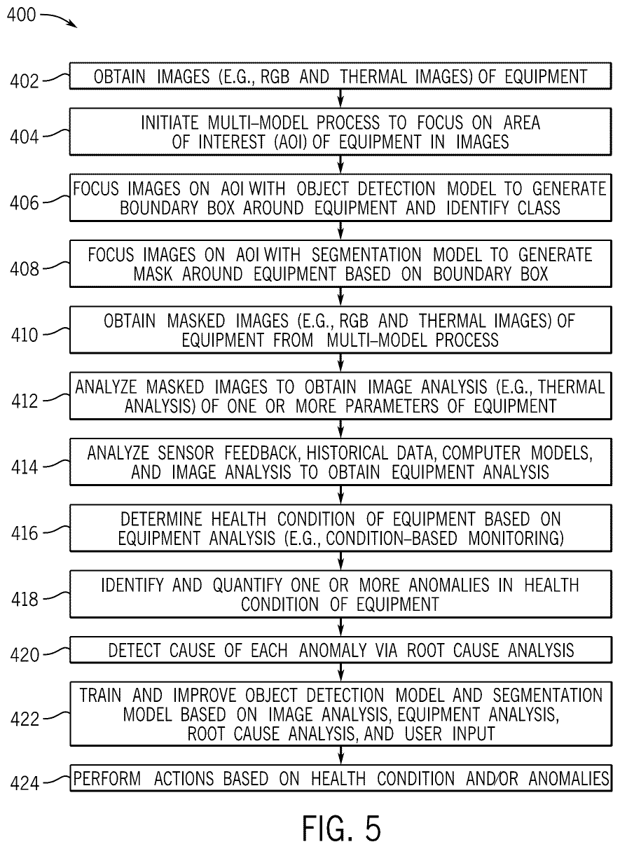

FIG. 5 is a flow chart of a process 400 for performing a thermal inspection of equipment in the facility 10, wherein the process 400 analyzes thermal images of the equipment via a multi-model process to identify anomalies and/or a health condition of the equipment. The process 400 may be performed by one or more processor-based computing devices, including the control system 100 of the UAV 14, the control system 122 of the docking station 16, and other computing devices (e.g., 16, 18, 20, 22, and/or 24). The process 400 also may include various aspects of the process 200 of FIG. 3 and the process 300 of FIG. 4. The equipment may include any of the equipment and assets 12 described herein.

In block 402, the process 400 obtains images of the equipment. The images may be obtained from the one or more fixed cameras and/or the one or more mobile cameras of the UAV 14. The images may be RGB images, thermal images, and/or optical gas images. In certain embodiments, the images may include multiple images taken at the same time and position using different camera types, so that multiple image types can be used to evaluate the condition of the equipment. In certain embodiments, the images may include multiple images taken at a plurality of different times (e.g., time increments of seconds, minutes, hours, or days) at the same position, such that trends in the images can be used to evaluate trends in conditions of the equipment. In certain embodiments, the images may include multiple images take at plurality of different orientations at one or more times, wherein the different orientation of the images can be used to evaluate the condition of the equipment. For example, the images may include multiple side view images around the equipment, a bottom view image of the equipment if the equipment is elevated, and/or a top view image of the equipment. The various images may be analyzed independently and/or in combination with one another in the process 400.

In block 404, the process 400 initiates the multi-model process to focus on the AOI of the equipment in the images. The multi-model process includes focusing the images using the object detection model and the segmentation model as discussed herein. In block 406, the process 400 focuses the images on the AOI with the object detection model to generate the boundary box around the equipment and identify the class of the equipment. The system may use the YOLO model as the object detection model. In addition or as an alternative to using the object detection model, the user may define a center point of the equipment on the images. In block 408, the process 400 focuses the images on the AOI with the segmentation model to generate the mask around the equipment based on the boundary box. The boundary box around the equipment may guide the segmentation model, so that the segmentation model recognizes the equipment as a single unit and does not further segment the equipment. In embodiments where the user has defined the center point of the equipment, the center point of the equipment may guide the segmentation model, so that the segmentation model recognizes the equipment as a single unit and does not further segment the equipment. The mask is overlaid onto the images to generate the masked images.

In block 410, the process 400 obtains the masked images of the equipment from the multi-model process. In block 412, the process 400 may analyze the masked images to obtain an image analysis of one or more parameters of the equipment. The image analysis may include a thermal analysis of one or more thermal images (e.g., masked thermal images) of the equipment. For example, the thermal analysis may include a thermal map of the equipment, and one or more thermal values of the equipment (e.g., an average temperature, a minimum temperature, a maximum temperature, etc.). The image analysis may also include analysis of the RGB images to determine one or more parameters of the equipment, such as a shape of the equipment, a position of an actuator of a valve, a position of a needle on a gauge or meter, or other positional or geometrical characteristics of the equipment.

In block 414, the process 400 may analyze sensor feedback, historical data, computer models, and the image analysis to obtain an equipment analysis. The sensor feedback may include measurements in real-time of a gas concentration, a fluid flow rate, a pressure, a temperature, a sound or noise, a vibration, a rotational speed, a power output, or any combination thereof, associated with the equipment. The equipment analysis may include one or more parameters of the equipment obtained via analysis of the sensor feedback, computer models, and/or image analysis. The equipment analysis may combine the one or more parameters with values for those parameters found in the historical data to better exhibit trends and anomalies.

In block 416, the process 400 may determine a health condition of the equipment based on the equipment analysis. That is to say, the process 400 may perform condition-based monitoring of the equipment. For example, if the equipment analysis shows the flowrate out of the equipment has been trending down for a particular period, the process 400 may determine the equipment is in poor health. Additionally, in block 418, the process 400 may identify and quantify one or more anomalies in the health condition of the equipment. For example, if the equipment analysis shows that the value of a maximum temperature parameter is much higher than the historical data shows, the process 400 may determine the equipment is in poor health and identify the maximum temperature parameter as the anomaly. By further example, if the equipment analysis shows that the maximum and/or average temperature is higher than a threshold combined with vibration and/or noise above a threshold, then the process 400 may determine the equipment is in poor health with anomalies in one or more parts. For example, the high temperatures, vibration, and/or noise may indicate wear and/or failure of one or more moving parts, such as bearings, seals, pistons, impellers, etc. In certain embodiments, the quantification of the anomaly may include an actual value of a measured parameter, an amount or percentage of the measured parameter over a threshold value, an anomaly score for each anomaly, or a combination thereof, as discussed above with reference to block 218 of the process 200 of FIG. 3. In certain embodiments, the quantification of the anomaly may include a score (e.g., a severity score) that indicates the severity of the anomaly on a scale (e.g., increasing severity from 1 to 10, 1 to 100, or the like). Additionally, in certain embodiments, the health condition of the equipment may include a health score (e.g., considering all anomalies, possibly with different weighting factors) that indicates the health of the equipment on a scale (e.g., increasing health from 1 to 10, 1 to 100, or the like).

In block 420, the process 400 may detect the cause of each of the one or more anomalies via a root cause analysis substantially the same as discussed above with reference to FIGS. 3 and 4. The process 400 may analyze the data bank to output the cause of the anomaly. For example, if the anomaly constitutes a high maximum temperature parameter of the equipment, the process 400 via the root cause analysis may determine damaged/missing insulation around the equipment caused the anomaly based on an analysis of the RGB images of the equipment. For example, if the anomaly constitutes high temperatures, vibration, and/or noise associated with the equipment, the process 400 via the root cause analysis may determine one or more bearings, seals, pistons, impellers, etc. are broken, loose, failing, and/or need immediate repair. The location of high temperatures (e.g., hots spots), the source location and frequency of vibration, and the source location and pattern of the noise may further identify the likely parts in the equipment that are failing by comparing the locations against a 3D model of the equipment.

In block 422, the process 400 may train and improve the object detection model and the segmentation model based on the image analysis, the equipment analysis, the root cause analysis, and user input. For example, the process 400 may include similar training as discussed above with reference to FIG. 4. As such, the object detection model may be rewarded for generating the boundary box to fit closely around the equipment and penalized for generating the boundary box that fails to capture the entirety of the equipment and/or fails to minimize the background captured. Additionally, the segmentation model may be rewarded for generating a mask that encompasses the equipment and penalized for generating a mask that includes background equipment or does not include the entirety of the equipment.

In block 424, the process 400 may perform actions based on the health condition and/or anomalies. For example, the actions of block 424 may be the same or similar as described in detail above with reference to block 220 of FIG. 3. The actions may include outputting a notification and/or outputting a report describing the health condition and/or anomaly; scheduling and executing an inspection via the sensors and/or cameras; scheduling a manual inspection and/or service of the object by a technician; generating a safe route for the technician to reach the location of the equipment; and adjusting one or more operating parameters of the facility 10 based on the health condition of the equipment and/or anomalies.

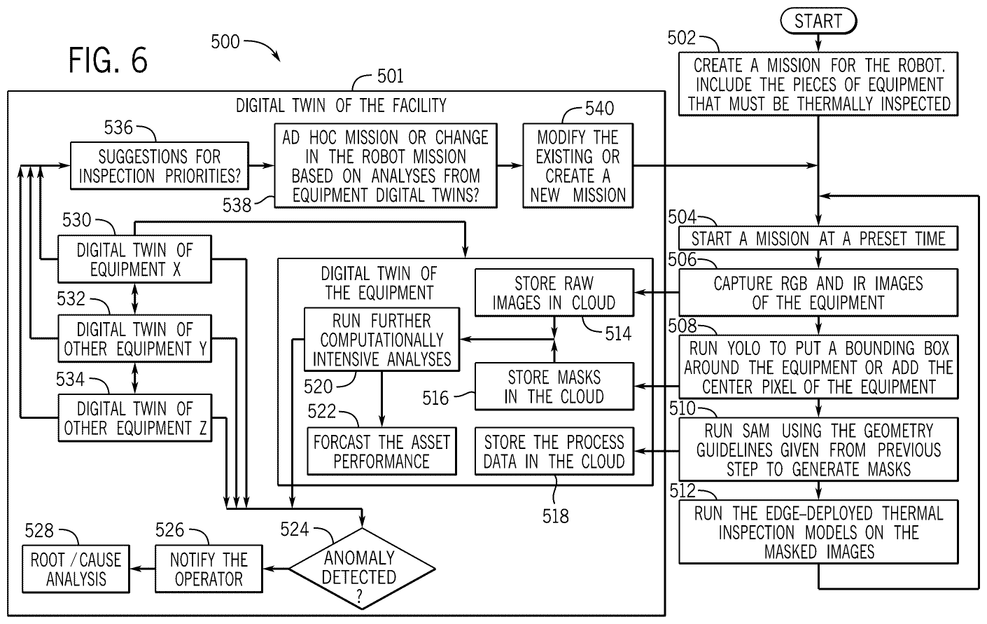

FIG. 6 is a flow chart of a process 500 for performing a thermal inspection of equipment in the facility 10 using the UAV 14. The process 500 may be performed by one or more processor-based computing devices, including the control system 100 of the UAV 14, the control system 122 of the docking station 16, and other computing devices (e.g., 16, 18, 20, 22, and/or 24). The process 500 also may include various aspects of the process 200 of FIG. 3, the process 300 of FIG. 4, and the process 400 of FIG. 5. The equipment may include any of the equipment and assets 12 described herein.

In block 502, the process 500 creates a mission for the UAV 14. The mission may be configured to include stops for the UAV 14 to inspect (e.g., obtain images and/or sensor feedback of) pieces of equipment the user wants to be inspected by sensors 15 of the UAV 14. The inspection may include a thermal inspection by thermal cameras of the UAV. However, the inspection may further include various images and sensor measurement by the UAV 14, the fixed sensors 13, and sensors integrated within the equipment. In block 504, the UAV 14 starts the mission at a preset time. The user may determine the preset time. The preset time may be a specified period of time after the last mission. During the mission, the process 500 obtains RGB and infrared (IR) images (i.e., raw images) of the equipment from the one or more mobile cameras of the UAV 14 in block 506. In block 514, the process 500 stores the raw images in the cloud 22, the UAV 14, the docketing station 16, and/or any combination of computing devices (e.g., 16, 18, 20, 22, and/or 24).

In block 508, the process 500 runs an objection detection model (e.g., YOLO) to generate the boundary box around the equipment in the image (e.g., RGB image, thermal image, optical gas image, etc.). Alternatively or additionally, the process 500 may add the center point to the equipment in the image. The center point may be added by the user or may be added using a machine learning algorithm.

In block 510, the process 500 runs SAM using the boundary box around the equipment and/or the center point of the equipment (i.e., geometry guidelines) in the image as generated in block 508 to generate the mask (e.g., masked image). The mask may encompass the entirety of the equipment within a masked border of the equipment in the image. In block 516, the process 500 stores the mask in the cloud 22.

In block 512, the process 500 runs the edge-deployed thermal inspection models on the masked images. The thermal inspection models may be run on the one or more edge devices 24. However, the thermal inspection models may be run on any suitable processor-based computing devices, such as the computing devices (e.g., 16, 18, 20, 22, and/or 24). In block 514, the process 500 stores the process data from the thermal inspection models in the cloud 22. The process 500 may repeat blocks 504-512 as often as is desired.

The process 500 may include a digital twin of the facility 501. The digital twin of the facility 501 is a computer model used to store the images and process data received in blocks 514-518, run computational analysis on the images to produce data, run simulations of the facility 10 using the data, and detect anomalies based on the data and simulations. The digital twin of the facility 501 may include the digital equivalents of the physical equipment inspected (hereinafter “the digital twins of the equipment”). The digital twin of the facility 501 may use one or more computers connected via the network and/or the cloud 22. The digital twin of the facility 501 may be configured to calculate additional parameters of the equipment based on the data and simulations. The digital twin of the facility 501 may be configured to determine whether the additional parameters constitute anomalies by comparing the additional parameters to user inputs, historical data, and/or operating specifications of the equipment.

As disclosed herein, the digital twin of the facility 501 receives and stores the raw images, the masks, and the process data of the thermal inspection model in the cloud 22 in blocks 514, 516, and 518 respectively. In block 520, the process 500 runs a further computationally intense analysis of the raw images and the masks stored in the cloud 22 to produce data regarding the equipment in the images. In block 522, the process 500 may use the analysis done in block 520 to forecast the performance of the equipment.

The process 500 may update the digital twins of the equipment X, Y, and Z in blocks 530, 532, and 534 respectively with the data output by the analysis of block 520. The digital twin of the equipment may be configured to include the parameters associated with the physical equipment. For example, the digital twin of the equipment may include the temperature, the pressure, the flowrate in, the flowrate out, the rotational speed, the fluid composition, and so forth of the corresponding physical equipment.

If the process 500 detects an anomaly in block 524, the process 500 may notify the operator in block 526 and/or may perform a root cause analysis in block 528. The anomaly may be an anomaly detected in the data output by the analysis of block 520 and/or an anomaly detected in the additional parameters as calculated by the digital twin of the facility 501.

Based on the data output by the analysis of block 520 and/or the additional parameters as calculated by the digital twin of the facility 501, the process 500 may make suggestions regarding inspection priorities in block 536. The suggestions may include prioritizing the inspection of equipment with anomalies over other equipment. The suggestions may also include prioritizing the inspection of equipment with severe anomalies over other equipment, such as by prioritizing the inspection of equipment based on a ranking of scores of the anomalies, a ranking of the health condition of the equipment, or a combination thereof. The process 500 may also determine whether to schedule an ad hoc mission or change the mission of the UAV 14 based on the inspection priorities as indicated in block 538. If the process 500 determines suggestions regarding inspection priorities warrant an ad hoc mission or a change to the existing mission, the process 500 may create a new mission or modify the existing mission in block 540. For example, the process 500 may schedule and create the ad hoc mission if the inspection priorities include equipment with highly urgent anomalies. Once the mission is created or modified, the process 500 may repeat the process 500 starting with block 504.

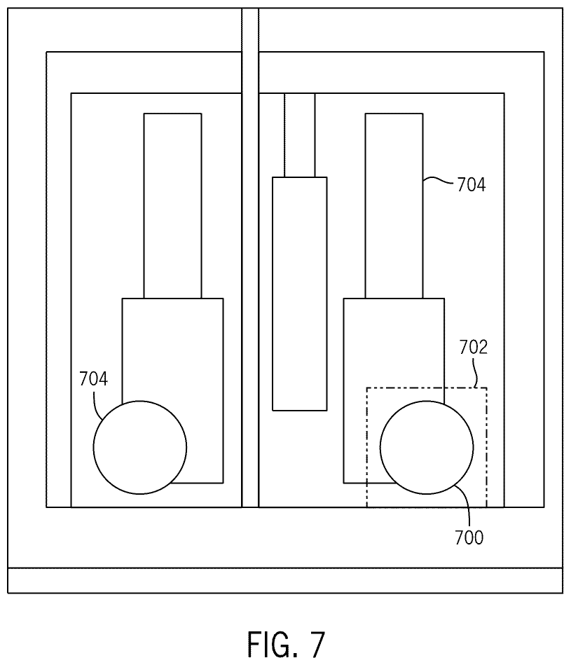

FIG. 7 is a schematic image of a pump 700 undergoing image analysis by an object detection model of the multi-model process of FIGS. 3-5, wherein the object detection model forms a boundary box 702 around the pump 700 in accordance with certain embodiments. The object detection model may receive images from the cameras, detect the equipment in the images, and generate the boundary box 702 around one or more equipment in the images. The images may include thermal images, RGB images, optical gas images, or a combination thereof. The object detection model may be configured to detect all equipment in the images, specific types of equipment (e.g., pumps, valves, heat exchangers, etc.), and/or a particular piece of equipment. In the illustrated embodiment, the object detection model is configured to detect and generate the boundary box 702 around the pump 700. The boundary box 702 may be configured to fit closely around the pump 700. In the illustrated embodiment, the boundary box 702 is a rectangular or square boundary box. However, the boundary box 702 may be a rectangular or square boundary box, a circular or oval boundary box, a polygonal boundary box having 3, 4, 5, 6, or more sides, or any combination thereof. The temperature profile and other data derived from the images is more exact the closer the boundary box 702 is to the pump 700. Thus, the object detection model may be configured to substantially exclude the background objects 704 from the boundary box 702. For example, the background objects may include a building structure (e.g., framework, walls, doors, floor, ceiling, etc.), trees and other vegetation, people and animals, and so forth. The object detection model may then output images with the boundary box to the segmentation model.

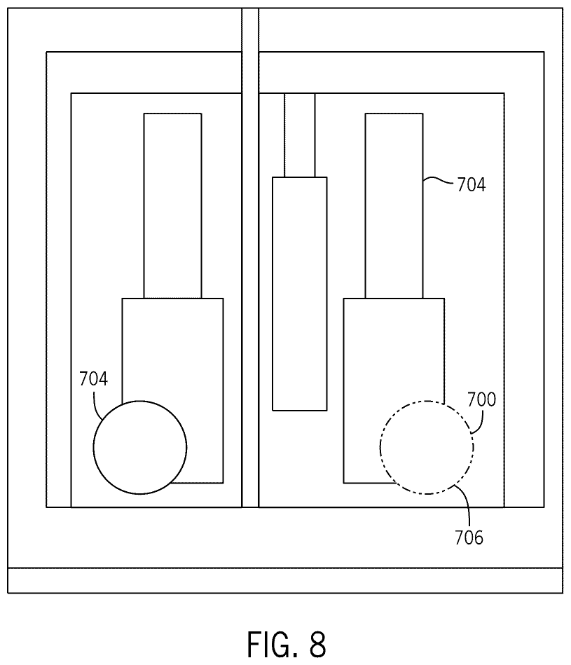

FIG. 8 is a schematic image of the pump 700 undergoing image analysis by a segmentation model after the object detection model forms the boundary box 702 in FIG. 7, wherein the segmentation model generates a masked image having a boundary fit directly about the pump in accordance with certain embodiments. The segmentation model may receive the images with the boundary box 702 and generate the mask 706 around the one or more equipment in the images. The boundary box 702 may serve as a guide for the segmentation model, such that the segmentation model focuses only on the image contained within the boundary box 702. As illustrated, the segmentation model generates the mask 706 around the pump 700 as it was contained in the boundary box 702. The mask may be configured to conform to a perimeter of the pump 700, such that the mask includes the entirety of the pump 700 while excluding all of the background objects 704. Thus, the mask 706 has the same geometry (e.g., shape and size) as the perimeter of the pump 700, such that only the pump 700 is contained within the mask 706. The mask 706 may be overlaid onto the images to generate the masked image. The system may analyze the masked image to determine the one or more parameters of the pump 700 as discussed in detail above.

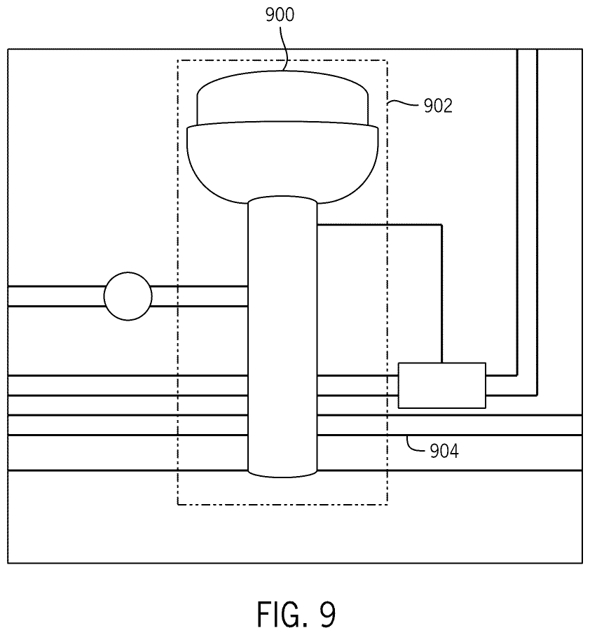

FIG. 9 is a schematic image of a valve 900 undergoing image analysis by an object detection model of the multi-model process of FIGS. 3-5, wherein the object detection model forms a boundary box 902 around the valve 900 in accordance with certain embodiments. As disclosed herein, the object detection model may receive images, detect equipment, and generate the boundary box 902 around one or more equipment in the images. The images may include thermal images, RGB images, optical gas images, or a combination thereof. In the illustrated embodiment, the object detection model is configured to detect and generate the boundary box 902 around the valve 900. The boundary box 902 may be configured to fit closely around the valve 900. In the illustrated embodiment, the boundary box 902 is a rectangular or square boundary box. However, the boundary box 902 may be a rectangular or square boundary box, a circular or oval boundary box, a polygonal boundary box having 3, 4, 5, 6, or more sides, or any combination thereof. However, while the object detection model is configured to minimize the background objects 904 included in the boundary box 902, the boundary box 902 may include background objects 904 as appropriate to fit the entirety of the valve 900 in the boundary box 902. The object detection model may then output images with the boundary box 902 to the segmentation model. Used alone, the thermal analysis of the objects in the boundary box 902 may produce wide variations in the temperature profile that do not reflect the temperature profile of the object. For example, the background objects 904 may be at an ambient temperature while the valve 900 is configured to be below the ambient temperature. Thus, the temperature profile of the valve 900 would reflect a higher maximum temperature than the valve 900 is experiencing. To correct for this issue, the system may apply the segmentation model to the images with the boundary box 902.

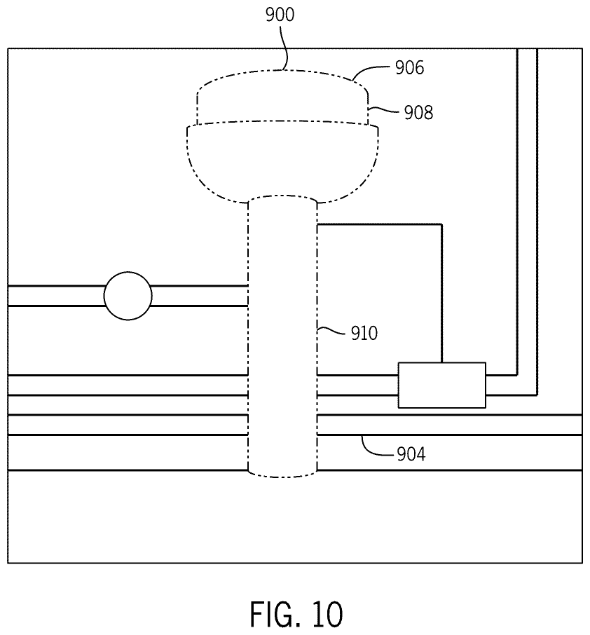

FIG. 10 is a schematic image of the valve 900 undergoing image analysis by a segmentation model after the object detection model forms the boundary box 902 in FIG. 9, wherein the segmentation model generates a masked image having a boundary fit directly about the valve 900 in accordance with certain embodiments. The segmentation model may receive the images with the boundary box 902 and generate the mask 906 around the one or more equipment in the images. Used alone, the segmentation model is likely to segment the valve 900 into various portions. For example, the segmentation model may segment the valve 900 into a top portion 908 and a bottom portion 910, thus producing two different temperature profiles for the same equipment. This may confuse the system and require human intervention to define the valve 900. To combat this issue, the boundary box 902 generated by the object detection model may serve as the guide for the segmentation model, such that the segmentation model focuses only on the image contained within the boundary box 902. As illustrated, the segmentation model generates the mask 906 around the valve 900 as it was contained in the boundary box 902. However, the mask 906 does not include the background objects 904 that were originally included in the boundary box 902. Thus, the mask 906 has the same geometry (e.g., shape and size) as the perimeter of the valve 900, such that only the valve 900 is contained within the mask 906. The mask 906 may be overlaid onto the images to generate the masked image. The system may analyze the masked image to determine the one or more parameters of the valve 900 as discussed in detail above.

Technical effects of the disclosed embodiments include a system and method for condition-based monitoring and control of equipment in a facility using images of the equipment, wherein the images are analyzed according to a multi-model process using object detection and segmentation models. The object detection model focuses on an area of interest (AOI) in the image, such as a particular piece of equipment, by bounding the equipment with a boundary box. In turn, the segmentation model uses the focus (e.g., boundary box) provided by the object detection model to further focus analysis of the image on the particular equipment by fitting a boundary directly around the equipment to obtain a masked image of the equipment. Thus, the multi-model process progressively focuses the image on the particular piece of equipment, thereby eliminating undesirable background information in the image. The disclosed embodiments then analyze the masked image to evaluate a health condition and/or identify one or more anomalies in the equipment. For example, the image analyzed by the disclosed embodiments may be a thermal image, and thus the analysis may identify thermal characteristics of the equipment, such as a temperature distribution, an average temperature, a maximum temperature, a minimum temperature, a temperature at one or more critical locations (e.g., bearings, seals, pistons, or friction-generating parts), a trend in temperature over time, or any combination thereof. The disclosed embodiments substantially improve accuracy of the image analysis by removing the undesirable background information that would otherwise skew the results (e.g., skewed average temperature, skewed maximum and minimum temperatures, skewed temperature trends, etc.). Additionally, the multi-model process substantially increases the efficiency and timelines of the image analysis for more immediate (e.g., real-time) monitoring and control of the equipment in the facility. In other words, the one or more computing devices (e.g., processor-based controllers) may be programmed with the multi-model process described herein to improve the efficiency, accuracy, and performance of the control of equipment in the facility. Thus, by more rapidly identifying anomalies in the equipment, the process can more rapidly control the equipment to reduce or eliminate the anomalies, protect the equipment, and maintain operations of the facility.

The subject matter described in detail above may be defined by one or more clauses, as set forth below.

A system for inspecting one or more equipment of a facility, including a processor and a memory having instructions executable by the processor, wherein the instructions are configured to obtain one or more images from one or more cameras, wherein the one or more images include an equipment. The instructions are further configured to focus the one or more images on an area of interest with an object detection model to generate a boundary box around the equipment, and focus the one or more images on the area of interest with a segmentation model to generate a mask around the equipment based on the boundary box.

The instructions are further configured to obtain one or more masked images from the segmentation model, and analyze the one or more masked images to obtain an image analysis of one or more parameters of the equipment.

The system of the preceding clause, including the one or more cameras.

The system of any preceding clause, wherein the one or more cameras include a thermal imaging camera.

The system of any preceding clause, wherein the one or more cameras include a fixed position camera and a mobile camera.

The system of any preceding clause, including an unmanned autonomous vehicle (UAV) having at least one of the one or more cameras, wherein the UAV is programmed to inspect the equipment.

The system of any preceding clause, wherein the image analysis includes a thermal analysis of the equipment.

The system of any preceding clause, wherein the image analysis includes a maximum temperature, a first location of the maximum temperature, a minimum temperature, a second location of the minimum temperature, an average temperature, or a combination thereof.

The system of any preceding clause, wherein the instructions are configured to determine a health condition of the equipment based at least partially on the image analysis.

The system of any preceding clause, wherein the instructions are configured to determine the health condition based at least partially on sensor feedback, historical data, one or more computer models, or a combination thereof, with respect to the equipment.

The system of any preceding clause, wherein the instructions are configured to identify one or more anomalies in the health condition of the equipment.

The system of any preceding clause, wherein the instructions are configured to adjust one or more operating parameters related to the equipment based on the health condition, the one or more anomalies, or a combination thereof.

The system of any preceding clause, wherein the instructions are configured to perform a root cause analysis to detect a cause of each of the one or more anomalies.

The system of any preceding clause, wherein the instructions are configured to: train the object detection model based on the image analysis, an equipment analysis based at least partially on the image analysis, the root cause analysis, user input, or any combination thereof; and train the segmentation model based on the image analysis, an equipment analysis based at least partially on the image analysis, the root cause analysis, user input, or any combination thereof.

The system of any preceding clause, wherein the instructions are configured to perform at least one of: execute an automated inspection of the equipment via the one or more cameras, one or more sensors, or a combination thereof, in response to the one or more anomalies; schedule a manual inspection, service, or both, of the equipment by a technician in response to the one or more anomalies; output a report describing the one or more parameters of the equipment; or output a notification of the one or more anomalies.

The system of any preceding clause, wherein the object detection model includes a You Only Look Once (YOLO) model and the segmentation model includes a Segment Anything Model (SAM).

A method for inspecting one or more equipment of a facility, including obtaining one or more images from one or more cameras, wherein the one or more images include an equipment. The method further includes focusing the one or more images on an area of interest with an object detection model to generate a boundary box around the equipment, and focusing the one or more images on the area of interest with a segmentation model to generate a mask around the equipment based on the boundary box. The method further includes obtaining one or more masked images from the segmentation model, and analyzing the one or more masked images to obtain an image analysis of one or more parameters of the equipment.

The method of the preceding clause, wherein the one or more cameras include a thermal imaging camera, and the image analysis includes a thermal analysis of the equipment.

The method of any preceding clause, wherein the object detection model includes a You Only Look Once (YOLO) model and the segmentation model includes a Segment Anything Model (SAM).

A tangible and non-transitory machine readable medium including instructions to obtain one or more images from one or more cameras, wherein the one or more images include an equipment. The medium further includes instructions to focus the one or more images on an area of interest with an object detection model to generate a boundary box around the equipment, and focus the one or more images on the area of interest with a segmentation model to generate a mask around the equipment based on the boundary box. The medium further includes instructions to obtain one or more masked images from the segmentation model, and analyze the one or more masked images to obtain an image analysis of one or more parameters of the equipment.

The medium of the preceding clause, wherein the one or more cameras include a thermal imaging camera, the image analysis includes a thermal analysis of the equipment, the object detection model includes a You Only Look Once (YOLO) model, and the segmentation model includes a Segment Anything Model (SAM).

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A system for inspecting one or more equipment of a facility, comprising:
a processor; and
a memory comprising instructions executable by the processor, wherein the instructions are configured to:
obtain one or more images from one or more cameras, wherein the one or more images include an equipment;
focus the one or more images on an area of interest with an object detection model to generate a boundary box around the equipment;
focus the one or more images on the area of interest with a segmentation model to generate a mask around the equipment based on the boundary box;
obtain one or more masked images from the segmentation model; and
analyze the one or more masked images to obtain an image analysis of one or more parameters of the equipment.

2. The system of claim 1, comprising the one or more cameras.

3. The system of claim 2, wherein the one or more cameras comprise a thermal imaging camera.

4. The system of claim 2, wherein the one or more cameras comprise a fixed position camera and a mobile camera.

5. The system of claim 2, comprising an unmanned autonomous vehicle (UAV) having at least one of the one or more cameras, wherein the UAV is programmed to inspect the equipment.

6. The system of claim 1, wherein the image analysis comprises a thermal analysis of the equipment.

7. The system of claim 6, wherein the image analysis comprises a maximum temperature, a first location of the maximum temperature, a minimum temperature, a second location of the minimum temperature, an average temperature, or a combination thereof.

8. The system of claim 1, wherein the instructions are configured to determine a health condition of the equipment based at least partially on the image analysis.

9. The system of claim 8, wherein the instructions are configured to determine the health condition based at least partially on sensor feedback, historical data, one or more computer models, or a combination thereof, with respect to the equipment.

10. The system of claim 8, wherein the instructions are configured to identify one or more anomalies in the health condition of the equipment.

11. The system of claim 10, wherein the instructions are configured to adjust one or more operating parameters related to the equipment based on the health condition, the one or more anomalies, or a combination thereof.

12. The system of claim 10, wherein the instructions are configured to perform a root cause analysis to detect a cause of each of the one or more anomalies.

13. The system of claim 12, wherein the instructions are configured to:
train the object detection model based on the image analysis, an equipment analysis based at least partially on the image analysis, the root cause analysis, user input, or any combination thereof; and
train the segmentation model based on the image analysis, an equipment analysis based at least partially on the image analysis, the root cause analysis, user input, or any combination thereof.

14. The system of claim 10, wherein the instructions are configured to perform at least one of:
execute an automated inspection of the equipment via the one or more cameras, one or more sensors, or a combination thereof, in response to the one or more anomalies;
schedule a manual inspection, service, or both, of the equipment by a technician in response to the one or more anomalies;
output a report describing the one or more parameters of the equipment; or
output a notification of the one or more anomalies.

15. The system of claim 1, wherein the object detection model comprises a You Only Look Once (YOLO) model and the segmentation model comprises a Segment Anything Model (SAM).

16. A method for inspecting one or more equipment of a facility, comprising:
obtaining one or more images from one or more cameras, wherein the one or more images include an equipment;
focusing the one or more images on an area of interest with an object detection model to generate a boundary box around the equipment;
focusing the one or more images on the area of interest with a segmentation model to generate a mask around the equipment based on the boundary box;
obtaining one or more masked images from the segmentation model; and
analyzing the one or more masked images to obtain an image analysis of one or more parameters of the equipment.

17. The method of claim 16, wherein the one or more cameras comprise a thermal imaging camera, and the image analysis comprises a thermal analysis of the equipment.

18. The method of claim 16, wherein the object detection model comprises a You Only Look Once (YOLO) model and the segmentation model comprises a Segment Anything Model (SAM).

19. A tangible and non-transitory machine readable medium comprising instructions to:
obtain one or more images from one or more cameras, wherein the one or more images include an equipment;
focus the one or more images on an area of interest with an object detection model to generate a boundary box around the equipment;
focus the one or more images on the area of interest with a segmentation model to generate a mask around the equipment based on the boundary box;
obtain one or more masked images from the segmentation model; and
analyze the one or more masked images to obtain an image analysis of one or more parameters of the equipment.

20. The medium of claim 19, wherein the one or more cameras comprise a thermal imaging camera, the image analysis comprises a thermal analysis of the equipment, the object detection model comprises a You Only Look Once (YOLO) model, and the segmentation model comprises a Segment Anything Model (SAM).
